(19) United States
(12) Patent Application Publication
(10) Pub. No.: US 2013/0251840 A1
(43) Pub. Date: Sep. 26, 2013

(54) Pre-Stretcher Assembly and Thermoforming Device

(71) Applicant: Gijsbertus Adrianus Johannes Baptist Smeulders, Waalwijk (NL)

(72) Inventor: Gijsbertus Adrianus Johannes Baptist Smeulders, Waalwijk (NL)

(73) Assignee: BOSCH SPRANG BEHEER B.V., Sprang-Capelle (NL)

(21) Appl. No.: 13/704,506

(22) PCT Filed: Jun. 15, 2011
(86) PCT No.: PCT/NL11/50430

§ 371 Date: Jan. 23, 2013

(30) Foreign Application Priority Data
Jun. 16, 2010 (NL) 2004904

(51) Int. Cl. B29C 51/08

(52) U.S. Cl. CPC B29C 51/082
USPC 425/394

(57) ABSTRACT

The present invention relates to a pre-stretcher assembly and a thermoforming device. The invention makes use of conical screw thread in combination with a stop so as to obtain a coupling system which can be coupled more quickly, results in a constant coupling and is less susceptible to wear. This makes the invention particularly advantageous for assemblable mould parts having a product-forming function, such as a pre-tensioner.

The present invention relates to a pre-stretcher assembly and a thermoforming device.

Thermoforming is a known technique. It makes use of the fact that with sufficient heating the form of thermoplastic materials such as polypropylene (PP), polystyrene (PS) or polyethylene (PET) can be changed.

A typical thermoforming device for forming the heated material comprises two moulds, an upper mould and lower mould, wherein the heated plastic material, preferably in the form of a sheet or foil, is carried between the two moulds.

When the mould halves are closed the plastic material is placed in the mould cavities of the mould by a pre-stretcher. These mould cavities are defined by the walls of a forming sleeve. A forming base for forming the base of the product is also arranged in the forming sleeve. An increased pressure is applied to press the plastic against the wall and the bottom of the mould cavity. Because the wall and the bottom of the cavity are kept at a relatively low temperature the plastic will take on a solid form. The combination of upper and lower mould usually comprises a plurality of mould cavities, and so also a plurality of forming bases and pre-stretchers. A plurality of products can hereby be formed from one sheet or foil.

It is a regular occurrence during production that the pre-stretchers have to be taken out of the mould. Examples hereof are that products with a different product height or product geometry must be produced, that the pre-stretchers have to be cleaned or that the parts in question are damaged. It is known to the skilled person that the condition and the form of a pre-stretcher are important for the material distribution and the quality of the product. Disassembly and assembly of these components is preferably carried out as quickly and simply as possible in order to minimize loss of production time.

In most cases a pre-stretcher core is arranged in the pre-stretcher to enable connection thereof to a pre-stretcher rod. The pre-stretcher rods are mounted on a pre-stretcher plate which can be driven mechanically. A plurality of products can be formed simultaneously by using a pre-stretcher plate.

Within the context of the present invention the combination of a pre-stretcher rod and a pre-stretcher is an example of an assemblable mould component. In the assembled state this mould component at least partly defines the form of the product to be formed during the thermoforming.

A problem of known thermoforming devices, and particularly of the pre-stretcher assemblies, is that changing a pre-stretcher takes too long and is too labour-intensive. The large number of this type of component in the mould, generally more than ten, combined with the time per component required to change and/or modify the component, makes the use of the above stated production lines less effective.

It is an object of the present invention to provide a coupling system, and particularly a pre-stretcher assembly comprising this coupling system, whereby the above stated problems do not occur, or hardly so.

This object is achieved with a coupling system according to the invention. Such a system can also be seen as an assembly of coupling parts which can be coupled.

The system comprises a first coupling part extending in a coupling direction and provided with a tapering outer end with conical screw thread. The system further comprises a second coupling part provided with a guide for guiding the first coupling part in the coupling direction through an opening in the guide and a tapering cavity connected to the opening and provided with conical screw thread. The first and second coupling parts can be coupled by mutual engagement of the conical screw threads.

The first coupling part comprises a stop element and the second coupling part a stop, the position of which in the coupling parts is chosen such that contact between stop element and stop prevents complete engagement of the conical screw threads. The guide is further adapted to fix the coupling parts relative to each other in a direction perpendicularly of the coupling direction in the case of contact between stop and stop element.

The above stated object of the present invention is likewise achieved with a pre-stretcher assembly comprising a pre-stretcher and a pre-stretcher rod to which the pre-stretcher can be coupled. The pre-stretcher rod is provided here with a first coupling part which extends in a coupling direction and which is provided with a tapering outer end with conical screw thread. The pre-stretcher further comprises a second coupling part which is provided with a guide for guiding the pre-stretcher rod in the coupling direction through an opening in the guide and a tapering cavity connected to the opening and provided with conical screw thread. The first and second coupling parts can also be coupled for the purpose of coupling the pre-stretcher to the pre-stretcher rod by mutual engagement of the conical screw threads.

The first coupling part comprises a stop element and the second coupling part a stop, the position of which in the coupling parts is chosen such that contact between stop element and stop prevents complete engagement of the conical screw threads. The stop element and the stop are formed by respectively the first coupling part and a wall of the second coupling part being set back in a direction perpendicularly of the coupling direction. The guide further extends from the stop and away from the tapering cavity in the second coupling part and is adapted to fix the coupling parts relative to each other in a direction perpendicularly of the coupling direction in the case of contact between stop and stop element.

A correct product definition is very important in thermoforming. An example hereof is the height of the product to be made or the thickness or distribution of the plastic in the product. These properties depend partially on the mould components. In the case of the above stated assemblable mould components it is therefore important that the coupling is constant and that particularly the distance between the elements for coupling remains constant over time.

Making use of conical screw thread instead of straight screw thread can achieve that the coupling parts can be coupled quickly, i.e. with a very small number of rotations. A coupling system is hereby obtained with which the different elements, such as a pre-stretcher rod and pre-stretcher, can be coupled and uncoupled quickly. Loss of production time can hereby be reduced.

Conical screw thread is used mainly for connecting pipe segments. A pipe segment has a tapering outer end here with conical screw thread. This outer end can be placed in another pipe segment having a tapering wall. The segments can be coupled by rotating the segments relative to each other. The coupling is complete when further rotation is no longer possible. In this case there is no, or hardly any, play between the different screw threads. This is particularly important in connections for a determined medium, such as a liquid or gas, wherein the connection may not result in leakage.

U.S. Pat. No. 2,772,899 also describes the use of conical screw thread for connecting drill pipe segments. One segment is provided here with a tapering part with conical screw thread on the outside and another segment with a corresponding tapering opening. Conical screw thread on the wall of the opening can co-act with the conical screw thread of the above stated segment for mutual connection of the segments. Both segments are further provided with a stop. These lie against each other at the moment the conical screw threads on the two segments are in full engagement with each other. Further relative rotation causes an elastic deformation of the two segments. This deformation is necessary to obtain a connection of the segments which is appropriate for this application.

The use of conical screw thread for mould components was not known when the present application was filed. Another aspect is that conical screw thread as used in pipe segments and in U.S. Pat. No. 2,772,899 cannot be applied for form-defining assemblable mould components. Firstly, such a connection is susceptible to wear because a relatively great force is applied to the ridges of the screw thread in order to obtain sufficient fixation. It is further difficult to guarantee the same distance between the elements for coupling when a plurality of assemblable mould components are used. Production variation and the effect of wear result in a variation in for instance the distance between pre-stretcher rod and pre-stretcher. The uniformity of the formed products will hereby decrease.

In contrast to U.S. Pat. No. 2,772,899, use is made in the coupling system according to the present invention of a stop and stop element to prevent the engagement between the conical screw threads being complete. If stop and stop element were absent, a further rotation would be possible.

As in the case of straight screw thread, the coupling parts are still fixed in the coupling direction in the case of incomplete engagement between the conical screw threads. Movement is however still possible in a direction perpendicularly thereof. This is because there is still space between the ridges of the conical screw thread. The guide is therefore adapted to fix the coupling parts relative to each other in a direction perpendicularly of the coupling device in the case of contact between stop and stop element. It is thus the combination of guide and the mutual engagement of the conical screw threads which provides for sufficient fixation.

The distance between the coupling parts is determined according to the invention by the positioning of the stop element and the stop. In the case of contact between stop and stop element less force is exerted on the ridges because the engagement of the conical screw thread is not complete. This results in less wear, and a good definition of the distance between the coupling parts remains ensured over time and the components need be replaced less quickly.

The stop element and the stop are preferably formed by respectively the first coupling part and a wall of the second coupling part being set back in a direction perpendicularly of the coupling direction. The stop element can be formed by having the outer dimension of the first coupling part decrease abruptly or very rapidly in the coupling direction. The stop can be formed in similar manner by changing a similar outer dimension of the cavity and/or opening of the guide.

It is advantageous for the stop element and the stop to form flat edge profiles. In the case of contact between stop element and stop there is a large contact surface resulting in a considerable friction force which prevents rotation between the coupling parts. This is important since the pre-stretcher is thermally and dynamically loaded during the thermoforming process.

In an advantageous embodiment of the coupling system the stop is formed at or close to the transition between the guide and the tapering cavity, and the stop element is placed behind the conical screw thread as seen from the outer end of the first coupling part. The functions of stop and conical screw thread are in this way separated.

The opening of the guide is preferably elongate in the coupling direction and fits closely onto the first coupling part when first and second coupling parts are coupled. The opening also fulfils an aligning function here for the purpose of placing the first coupling part in the correct position before bringing the conical screw threads into contact with each other. This increases the uniformity of the coupling of mould component to mould component and prevents excessive asymmetrical forces on the ridges of the screw threads due to incorrect alignment.

It is advantageous for the coupling system to comprise further coupling means which are adapted to hold the first and second coupling parts coupled after the engagement of the conical screw threads is broken, wherein the coupling is sufficiently strong to prevent uncoupling between the first and second coupling parts as a result of gravitational force. In the case of a pre-stretcher, which is usually received in the upper mould of a thermoforming device, unscrewing of the pre-stretcher does not therefore result in a situation where the pre-stretcher drops downward under the influence of gravitational force and is possibly damaged. Instead it remains coupled to the pre-stretcher rod, albeit that this is a loose coupling.

Such a coupling can be realized with a recess in the first or second coupling part and a resilient O-ring co-acting therewith in the other coupling part. The O-ring can engage on the recess, for instance by penetrating into the recess, whereby the coupling parts remain coupled.

The O-ring is preferably placed on an inner side of the guide and the recess is placed above the tapering outer end as seen from the outer end of the first coupling part.

The outer end of the first coupling part and the cavity of the second coupling part taper relative to the coupling direction, preferably at an angle between 10 and 25 degrees, more preferably at an angle between 12 and 20 degrees, and most preferably at an angle between 13 and 17 degrees. An advantageous coupling system, which can on the one hand be coupled quickly but which on the other provides sufficient strength to withstand the forces during the thermoforming process, is achieved particularly in combination with a pitch of the conical screw thread of between 5 and 15 and more preferably between 9 and 10 rotations per 1 cm. Use can also be made of multi-start screw thread. Fewer rotations are hereby necessary for (dis)assembly of the connection. The length in the coupling direction along which the conical screw threads engage each other in the case of contact between stop element and stop is at least 3 mm, and more preferably at least 6 mm.

The ridges of the conical screw thread preferably extend perpendicularly from a wall of the first coupling part or a wall of the second coupling part. Increasing the support surface of the (screw thread) ridge will result in a better connection.

The coupling system according to the invention can be used in a thermoforming device. In that case the thermoforming device comprises an assemblable mould component with the first and second coupling parts as defined in any of the foregoing claims.

An example of such an assemblable mould part comprises a pre-stretcher and a pre-stretcher rod. The first coupling part is received here in the pre-stretcher rod and the second coupling part in the pre-stretcher.

The invention will be discussed in more detail hereinbelow with reference to the accompanying figures, wherein identical reference numerals are used to designate identical or similar parts, and wherein:

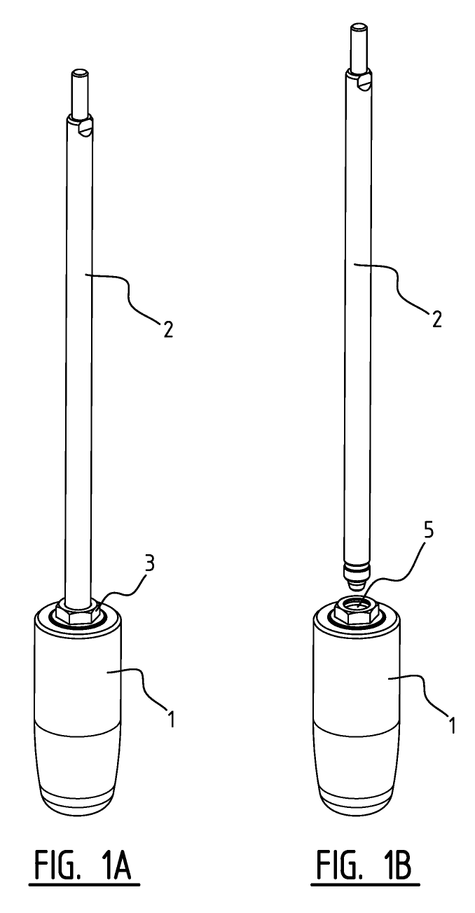

FIGS. 1A-1B show a pre-stretcher comprising the coupling system according to the invention in respectively coupled and uncoupled situation;

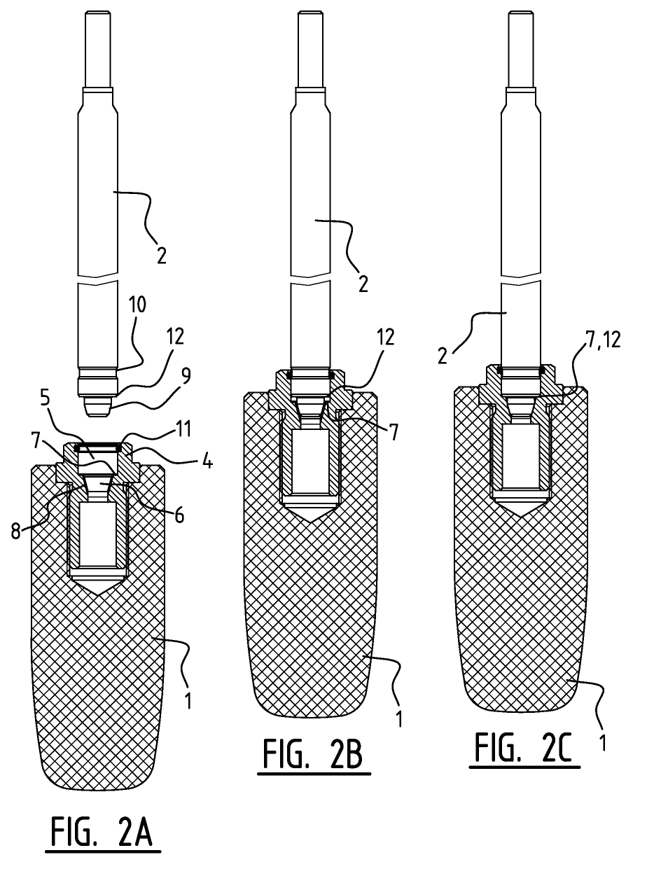

FIGS. 2A-2C show cross-sections of the pre-stretcher of FIGS. 1A and 1B;

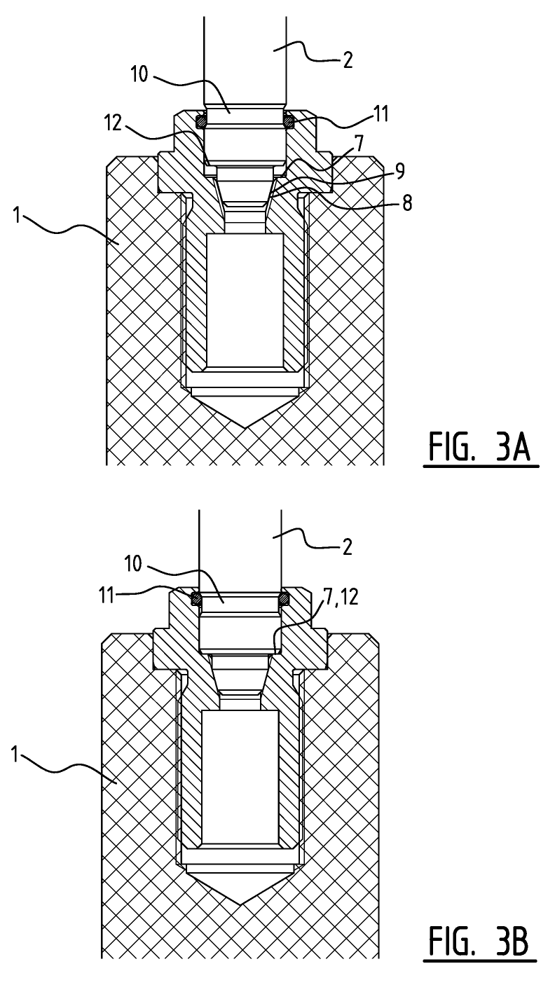

FIGS. 3A-3B show detail views of respectively FIG. 2B and 2C; and

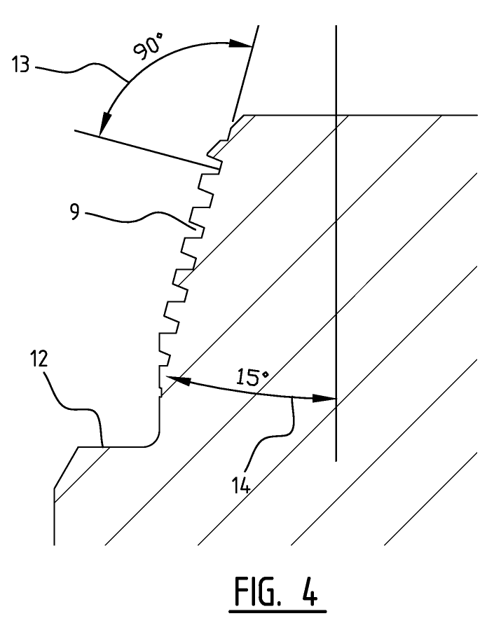

FIG. 4 shows a view of a possible detail of the outer end of the first coupling part.

FIG. 1A shows a pre-stretcher 1 which is coupled to a pre-stretcher rod 2. The coupling system according to the invention is incorporated in this mould component. Pre-stretcher 1 comprises the second coupling part, visible in FIGS. 2A-2C, and pre-stretcher rod 2 comprises the first coupling part. Pre-stretcher 1 is further provided with a nut-like part 3 whereby pre-stretcher rod 2 can be unscrewed in simple manner using an open-end spanner.

FIG. 2A shows a cross-section of the pre-stretcher of FIG. 1A. A guide 4 with an opening 5 are can be seen in pre-stretcher 1. A tapering cavity 6 connects to opening 5. At the boundary surface of opening 5 and cavity 6 a wall of the cavity/opening is set back, thereby creating a stop 7 with an edge profile, see FIG. 3A for detail view. The wall of cavity 6 is further provided with conical screw thread 8.

Pre-stretcher rod 2 comprises the first coupling part. It has a tapering outer end with a conical screw thread 9. Pre-stretcher rod 2 is substantially cylindrical, with the exception of the outer end and a recess 10. This recess can co-act with an O-ring 11, as will be elucidated below. At the boundary between the cylindrical part and the tapering outer end rod 2 is set back, whereby a stop element 12 is formed. Just as stop 7, this element takes the form of an edge profile.

FIG. 2A shows the pre-stretcher in uncoupled situation. In order to arrive at the assembled situation, pre-stretcher 1 is placed over the outer end of pre-stretcher rod 2 in the coupling direction. O-ring 11 will hereby engage in recess 10. Created as a result is a coupling between pre-stretcher 1 and pre-stretcher rod 2 which is sufficient to prevent uncoupling due to gravitational force. As can be seen in FIG. 2B, at this stage there is as yet no contact between stop 7 and stop element 12. Pre-stretcher 1 is then pushed in the direction of pre-stretcher rod 2 and rotated. The conical screw threads of the two parts will hereby engage each other. Recess 10 and O-ring 11 can be embodied such that they remain coupled during the pushing and rotating movement.

After a small number of rotating movements, stop 7 and stop element 12 will contact each other, whereby further rotation is blocked. This situation is shown in FIGS. 2C and 3B. It is important to note that in the absence of stop 7 and stop element 12 pre-stretcher 1 can be rotated still further before the conical screw threads fully engage each other. This means that in the case of contact between stop 7 and stop element 12 there is still play in directions perpendicularly of the coupling direction. This play is dealt with by guide 4. This fits closely onto pre-stretcher rod 2, whereby movement of this rod in directions perpendicularly of the coupling device is prevented or greatly limited. Fixation in the coupling direction itself is realized by the mutual engagement of conical screw threads 8, 9, and then particularly the ridges thereof.

Because stop 7 and stop element 12 take a flat form there is a relatively large contact surface. The hereby realized friction force reduces the chance of rotation of pre-stretcher 1 relative to pre-stretcher rod 2 during operation of the thermoforming device.

FIG. 4 shows a detail view of the tapering outer end of the first coupling part of pre-stretcher rod 2. This figure shows the perpendicular arrangement of the ridges as indicated by arrow 13. It is further recommended to select an angle of about 15 degrees of the tapering outer end relative to the coupling direction, as indicated by arrow 14. The coupling direction corresponds here with the axial direction of pre-stretcher rod 2.

The above stated description shows that the invention provides a coupling system which enables a simple, quick and reliable change and/or adjustment of mould components.

The invention is moreover particularly suitable for thermoforming devices, a mould of which comprises an assembled mould component consisting of two or more elements which are coupled or assembled by the coupling system according to the invention.

Embodiments of the present invention are discussed with reference to the accompanying figures. It will be apparent to the skilled person that various modifications are possible without departing from the scope of protection defined by the following claims.

1. Pre-stretcher assembly, comprising
a pre-stretcher;
a pre-stretcher rod to which the pre-stretcher can be coupled;
wherein the pre-stretcher rod is provided with a first coupling part which extends in a coupling direction and which is provided with a tapering outer end with conical screw thread;
wherein the pre-stretcher comprises a second coupling part which is provided with a guide for guiding the pre-stretcher rod in the coupling direction through an opening in the guide and a tapering cavity connected to the opening and provided with conical screw thread;
wherein the first and second coupling parts can be coupled for the purpose of coupling the pre-stretcher to the pre-stretcher rod by mutual engagement of the conical screw threads ;
characterized in that
the first coupling part comprises a stop element and the second coupling part a stop, the position of which in the coupling parts is chosen such that contact between stop element and stop prevents complete engagement of the conical screw threads, wherein the stop element and the stop are formed by respectively the first coupling part and a wall of the second coupling part being set back in a direction perpendicularly of the coupling direction, and
the guide extends from the stop and away from the tapering cavity in the second coupling part and is adapted to fix the coupling parts relative to each other in a direction perpendicularly of the coupling direction in the case of contact between stop and stop element.

2. Pre-stretcher assembly as claimed in claim 1, wherein the stop element and the stop form flat edge profiles.

3. Pre-stretcher assembly as claimed in claim 1, wherein the stop is formed at or close to the transition between the guide and the tapering cavity, and wherein the stop element is placed behind the conical screw thread as seen from the outer end of the first coupling part.

4. Pre-stretcher assembly as claimed in claim 1, wherein the opening of the guide is elongate in the coupling direction and fits closely onto the first coupling part when first and second coupling parts are coupled.

5. Pre-stretcher assembly as claimed in claim 1, comprising further coupling means which are adapted to hold the first and second coupling parts coupled after the engagement of the conical screw threads is broken, wherein the coupling is sufficiently strong to prevent uncoupling between the first and second coupling parts as a result of gravitational force.

6. Pre-stretcher assembly as claimed in claim 5, wherein the further coupling means comprise a recess in the first or second coupling part and a resilient O-ring in the other coupling part, wherein the O-ring can engage on the recess for the purpose of said holding coupled.

7. Pre-stretcher assembly as claimed in claim 6, wherein the O-ring is placed on an inner side of the guide and the recess is placed above the tapering outer end as seen from the outer end of the first coupling part.

8. Pre-stretcher assembly as claimed in claim 1, wherein the outer end of the first coupling part and the cavity of the second coupling part taper relative to the coupling direction at an angle between 10 and 25 degrees, preferably at an angle between 12 and 20 degrees, and most preferably at an angle between 13 and 17 degrees.

9. Pre-stretcher assembly as claimed in claim 1, wherein a pitch of the conical screw thread lies between 5 and 15 and more preferably between 9 and 10 rotations per 1 cm and/or the conical screw threads take a multi-start form.

10. Pre-stretcher assembly as claimed in claim 1, wherein the length in the coupling direction along which the conical screw threads engage each other in the case of contact between stop element and stop is at least 3 mm, and more preferably at least 6 mm.

11. Pre-stretcher assembly as claimed in claim 1, wherein ridges of the conical screw thread extend perpendicularly from a wall of the first coupling part or a wall of the second coupling part.

12. (canceled)
